(19) United States
(12) Patent Application Publication
(10) Pub. No.: US 2009/0043717 A1
(43) Pub. Date: Feb. 12, 2009

(54) METHOD AND A SYSTEM FOR SOLVING DIFFICULT LEARNING PROBLEMS USING CASCADES OF WEAK LEARNERS

(76) Inventors: Pablo Zegers Fernandez, Santiago (CL); Gonzalo Correa Aldunate, Santiago (CL)

Correspondence Address: HASSE & NESBITT LLC, 8837 CHAPEL SQUARE DRIVE, SUITE C, CINCINNATI, OH, 45249, US

(21) Appl. No.: 12/189,407

(22) Filed: Aug. 11, 2008

(30) Foreign Application Priority Data
Aug. 10, 2007 (CL) 2345/2007

(51) Int. Cl. G06F 15/18; G06F 17/10

(52) U.S. Cl. 706/12; 708/401; 708/201

(57) ABSTRACT

A method and a system for designing a learning system (30) based on a cascade of weak learners. Every implementation of a cascade of weak learners is composed of a base block (60) and a cascade of identity blocks (80). The output (70, 90) of each of the learning subsystems (60, 80) is fed into the following one. The external output (10) is fed to cach of the learning subsystems to avoid ambiguities. The identity blocks (80) are designed to include the identity function within the class of functions that they can implement. The weak learners are added incrementally and each of them trained separately while the parameters of the others are kept frozen.

### BACKGROUND OF THE INVENTION

It is very common to observe that learning machines are not able to reach the desired solutions. This is usually true in difficult problems where it is not possible to assess whether the neural network does or does not in fact include the solution in its set of potential functions, or if it has simply become trapped in a suboptimal parameter configuration and it has stopped training, unable to find the right solution. This weakness of many learning machines (LMs) explains in part the popularity reached by techniques such as the support vector machine (SVM), described in references [1], [2], [3], the disclosures of which are incorporated herein by reference, which does ensure reaching the global optimum, and in cases such as the least squares SVM [4] it does so in one step with the help of a non-iterative optimization algorithm. If these methods are already available one may wonder, why continue using other learning machines? One very simple and important reason is efficiency. Many of these seemingly weak learning machines are able to generate solutions that are far more compact in terms of number of parameters than those produced by SVM, if they manage to generate these solutions.

In general the capacity of an arbitrary LM is relative to the problem to be solved. If the problem to be solved is simple, the LM may exhibit a great capacity. If not, it may perform poorly. However, within the context of some specific problem, the capacity of a LM machine is solely determined by the data set, mainly its size and the actual data samples, the performance measure, which can affect enormously the way a LM behaves, its architecture, which defines the set of functions that can be implemented, and its training algorithm, which comprises the generation of initial conditions, the optimization procedure, and the stopping rule. Given a fixed data set and a certain performance measure, the LM designer normally resorts to increasing the architecture complexity, which forces him to face the curse of dimensionality, or to improving the training algorithm in order to produce a capable LM. However, there are many cases where changing the architecture and the training algorithm are not practical approaches and a solution has to be found with whatever LM is already available. This is crucial in problems where there is no learning machine expert available and a certain function has to be approximated from some data set in an autonomous manner.

Summing up, existing literature and prior art focus mostly in the trajectory generation problem and do not address the more general case: the dynamical function-mapping problem. They do not provide a simple and practical solution for dynamical problems in general. Some of the solutions work for simple trajectory generation problems but how they scale to higher dimensionalities is not known. Others provide general solutions but they operation is not very satisfactory. And most approaches of the prior art ignore the stability problem and cannot guarantee convergence of the learning systems to a solution. This fact renders most of these approaches useless when it comes to designing all-purpose learning machines.

This work improves existing ways of reutilizing weak learners in order to generate function approximators that reach the desired solutions with high probability. The main design guidelines on which this work is based are: 1) to keep the hypothesis space small such that the training process proceeds in low-dimensionality spaces therefore avoiding the curse of dimensionality, and 2) to build the final solution by means of an incremental process.

These guidelines have been used by many researchers to create strong learners from the very start of the neural networks field (references [5], [6], [7], [8], [9], the disclosures of which are incorporated herein by reference). These efforts have focused mainly on incremental techniques that use weak LMs in each step in order to avoid the curse of dimensionality and later add them into a strong ensemble that solves the desired problem. One of the most relevant of these additive approaches has been the boosting method (reference [10], the disclosures of which are incorporated herein by reference), which has allowed solving classification problems using ensembles of arbitrary learning machines with great success.

This work will depart from the mainstream results, represented by incremental additive methods such as bagging [9] and boosting [10], and focus on simplifying the solutions presented in previously existing work (references [11], [12], [13], the disclosures of which are incorporated herein by reference), based on cascaded systems, which are mathematically equivalent to function compositions.

### BRIEF SUMMARY OF THE INVENTION

The invention consists of a method and a system for designing a cascade of weak learners able to behave as a strong machine with high probability of solving complex problems. The cascade is built incrementally such that training complexity is always kept low. The first stage of the cascade consists of a base block made up by any learning machine. Once this system is done with training, an identity block is added such that its input is composed by the external input and that of the base block. The identity block is called in that way because it includes the identity function within the class of functions that it can implement. Being another learning machine, the identity block is trained until it cannot improve its performance. Once this happens, another identity block is added, one whose input is defined by the external input again and the output of the previous identity block. Identity blocks are added to the system while the overall performance of the system improves.

The invention offers a simple and practical solution for learning problems in general, problems such as classification, function approximation, etc. Thanks to the continuous composition of outputs, the resulting cascade of weak learners has a high probability of solving problems that normally are very difficult to solve due to their high dimensionality or the existence of numerous local minima that force the system to fall in useless configurations.

Furthermore, an implementation of the cascade of weak learners has the additional advantage in that it tackles the training problems as a function composition problem as opposed to boosting, a learning paradigm that has been successfully used in classification problems and that it is based on function additions. Another advantage is that many different performance measures can be used: Euclidean distances, Lₚ norms, differential entropy, etc. Also, the base block and the identity blocks need not to have the same architecture: all of them can be different. And, any type of learning machine can be used to implement each of the weak learners.

The invention further provides a method to solve complex problems, including classification, function approximation, and dynamic problems, wherein a cascade of weak learners is used, which employs any learning machine that uses an identity block to compose the input by the external input and that of the base block during the training process. In the method, wherein for a set of N i.i.d. samples S_{N}={(xᵢ, ŷᵢ)}ᵢ₌₁^{N}, with xᵢε [symbol] ^{r}, and ŷᵢε [symbol] ^{s}, obtained from a process f: [symbol] ^{r}× [symbol] ^{t}→ [symbol] ^{s}, a performance index defines the approximation to the classical implementation function f: R^{r}×R^{t}→R^{s}, the output ŷεR^{s} of the learning machine is defined by ŷ=\hat{f}(x, θ), with xεR^{r} its input, and θ_{f}εR^{t} the parameters that define the learning system; wherein a basis block implements the function g: R^{r}×R^{u}→R^{s}, which can be expressed as g(x, θ_{g}), with xεR^{r}, and θ_{g}εR^{u}, where θ_{g} sets the parameters that define the base function; and wherein the identity block is defined by h: [symbol] ^{r}× [symbol] ^{s}× [symbol] ^{v}→ [symbol] ^{s}, which can be expressed as h(x, ŷ, θ), with xεR^{r} (10), ŷεR^{s} (50), and θεR^{v}, the notation hⱼ denotes an identity block evaluated with the parameter vector θⱼ. The method can comprise the steps of: 1) training the base block g to be as close to the observed data as possible according to the chosen performance index, where initially the learning machine is composed only by the base block \hat{f}=g; and wherein if the achieved performance is adequate, then go to step 4, or else set the identity block index j to 0 and proceed to the next step; 2) incrementing the identity block index to j=j+1 and adding a new identity block to the system, whereby the learning machine is mathematically defined by the nested system of equations

\hat{f}(x, θ_{f})=ŷⱼ

\hat{y}ⱼ=hⱼ(x, ŷⱼ₋₁, θⱼ) . . .

ŷ₁=h₁(x, b, θ₁)

b=g(x, θ_{g})
wherein θᵣ=θ_{g}×θ₁× . . . ×θⱼ;
   3) freezing the parameter vectors θ_{g} and θₖ, kε{1, . . . , j−1}, and training the newly added identity block, whose vector of parameters θⱼ is the only one that can change in θᵣ, until a set of parameters that achieves the best possible performance index is found; and wherein if the newly found performance index improves, then go to step 2 to continue adding identity blocks, or else remove the last identity block, the one that was trained last, and go to the next step; and 4) stopping.

Further objects and advantages of the invention will become clearer after examination of the drawings and the ensuing description.

### BRIEF DESCRIPTION OF THE DRAWINGS

FIG. 1 illustrates the general setup of a learning problem and the relation between external input x (10), reference system or process f (20), desired output y (40), learning system or learning machine \hat{f} (30), and the system's generated output ŷ (50).

FIG. 2 depicts the relationship between the different components of the cascade of weak learners that results from applying the cascaded learning method, where (60) is the base block, (70) is the output of the base block, (80) represents several identity blocks, and (90) output of the identity block

FIG. 3 shows the best performance of a single multilayer perceptron that has been used to learn a steps function.

FIG. 4 shows the best performance obtained with a cascade of weak learners, each a single multilayer perceptron such as the one whose performance was shown in FIG. 3, that has been used to learn a steps function.

FIG. 5 shows the histogram of the final errors obtained by 100 instances of the multilayer perceptron, and by 100 instances of the cascade of weak learners.

### DETAILED DESCRIPTION OF THE INVENTION

The invention is based on the following underlying insights.

It is always possible to easily design an identity block learning system 80 that at least in theory can behave as an identity function and copy its inputs into its outputs. This means that it should be possible to train a weak base learning block 60 and feed its output 70 into one of these identity systems 80. Training of this identity system 80 should have a good chance of improving on the previous block's performance given that it will start behaving as an identity and then improving its performance. Thus, cascading many of these identity blocks 80 should produce noticeable improvements in the learning performance of the overall learning machine, until the final output 50 resembles the desired behavior 40 more closely.

The resulting learning system 30 ends up composed by a complex cascade of simple systems (60 and 80) whose training was done incrementally and, therefore, was kept simple all the time.

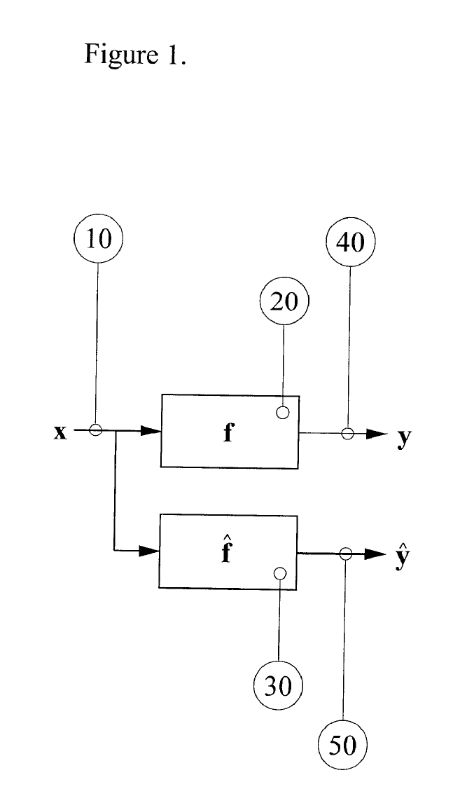

The context of a typical learning problem is defined by the schematic shown in FIG. 1. In this setup it is assumed the existence of a set of N i.i.d. samples S_{N}={(xᵢ, yᵢ)}ᵢ₌₁^{N}, with xᵢεR^{r} (10), and yᵢεR^{s} (40), obtained from a process f: R^{r}→R^{s} (20). A classical learning machine problem consists in finding a system that implements the function \hat{f}: R^{r}×R^{t}→R^{s} (30), such that f and \hat{f} are close according to some performance index. The output ŷεR^{s} (50) of the learning machine is defined by ŷ=\hat{f}(x, θ), with xεR^{r} (10) its input, and θᵣεR^{t} the parameters that define the learning system.

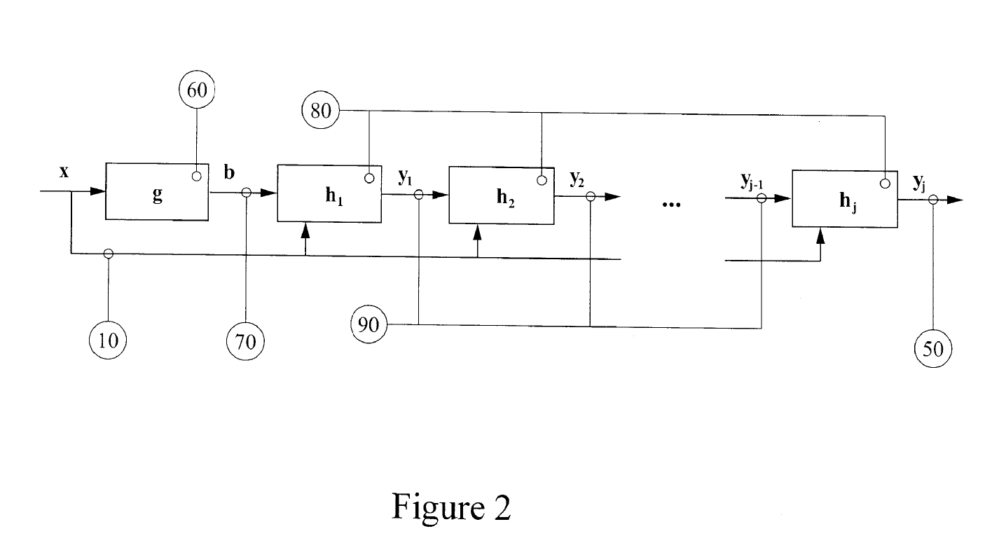

Next, we will present an incremental architecture building procedure based on function compositions capable of producing a cascade of weak learners with high probability of having a good behavior. Function composition implies using the output of a system as input to another. One way of reusing the output of a block and improving it with another is shown in FIG. 2. The input x (10) is fed to all the modules in order to avoid ambiguities in the learning process. The cascaded system depicted in FIG. 2 is implemented with a base block and cascaded copies of what we call identity blocks for reasons that will become clear later. The base block implements the function g: R^{r}×R^{u}→R^{s} (60). This function can be expressed as g(x, θ_{g}) (60), with xεR^{r} (10), and θ_{g}εR^{u}. The vector θ_{g} sets the parameters that define the base function. The identity block is defined by h: R^{r}×R^{s}×R^{v}→R^{s} (80). This function can be expressed as h(x, ŷ, θ) (80), with xεR^{r} (10), ŷεR^{s} (50), and θεR^{v}. As before, the notation hⱼ denotes an identity block evaluated with the parameter vector θⱼ.

The procedure used to obtain the learning machine specified in FIG. 2 is described by the following steps:

In Step 1), initially, the learning machine is composed only by the base block \hat{f}=g (30). The base block g (60) is trained to be as close to the observed data as possible according to the chosen performance index. If the achieved performance is adequate, then go to step 4, else set the identity block index j to 0 and proceed to the next step.

In Step 2), one increments the identity block index to j=j+1 and adds a new identity block to the system as shown in FIG. 2. Now the learning machine is mathematically defined by the nested system of equations

\hat{f}(x, θᵣ)=ŷⱼ

ŷⱼ=hⱼ(x, ŷⱼ₋₁, θⱼ) . . .

ŷ₁=h₁(x, b, θ₁)

b=g(x, θ_{g})
wherein θᵣ=θ_{g}×θ₁× . . . ×θⱼ.

In step 3), one freezes the parameter vectors θ_{g} and θₖ, kε{1, . . . , j−1}, and trains the newly added identity block, whose vector of parameters θⱼ is the only one that can change in θᵣ, until a set of parameters that achieves the best possible performance index is found. If the newly found performance index improves, then go to step 2 to continue adding identity blocks, else remove the last identity block, the one that was trained last, and go to the next step.

Step 4), stop.

As the system converges to the desired solution, the final learning blocks should converge to behave as identity blocks ŷⱼ=hⱼ(x, yⱼ₋₁, θⱼ)≈ŷⱼ₋₁. Therefore, the class of functions that each identity block hⱼ (80) implements should also include the identity function This is the reason why they are called identity blocks.

### EMBODIMENTS

The different embodiments that follow reflect some of the different ways in which the presented cascade of weak learners can be implemented.

Many performance indexes can be used to obtain the cascade of weak learners. Some examples are the Euclidean distance or information theoretical measures such as the entropy.

Any learning machine either based on digital computers or analog circuits can be used to implement the base (60) and identity blocks (80). The only constraint for the identity block (80) is that it should be able to implement the identity function, i.e. copy the output of the previous block as its own output.

Notice that the base block (60) may be implemented using an identity block (80) whose extra inputs are clamped to some constant, hence not relevant in the training process.

It is also important to point out that even though the identity blocks (80) need to include the identity function within the class of functions that they implement, they do not need to implement the same family of functions. This implies that each of the identity blocks (80) can be different, with different levels of learning capacity.

Also, it can be important how the identity blocks (80) are initialized before they are added to the system. Therefore there are several alternatives:

1. Nothing is done and the parameters of the identity system (80) are randomly initialized.

2. The identity blocks (80) are set to behave as an identity before the training process starts. This can be done by manually setting the values that produce this behavior or by using a pre-training process that turns the learning machine (80) to behave as an identity function.

3. The previously trained identity block (80) is used to produce the parameters of the new learning machine (80). When all the identity blocks (80) are identical, this reduces to copying the previously trained learning machine (80) and defining the copy as the new identity block (80). Obviously, the first identity block cannot use this strategy.

### EXAMPLE

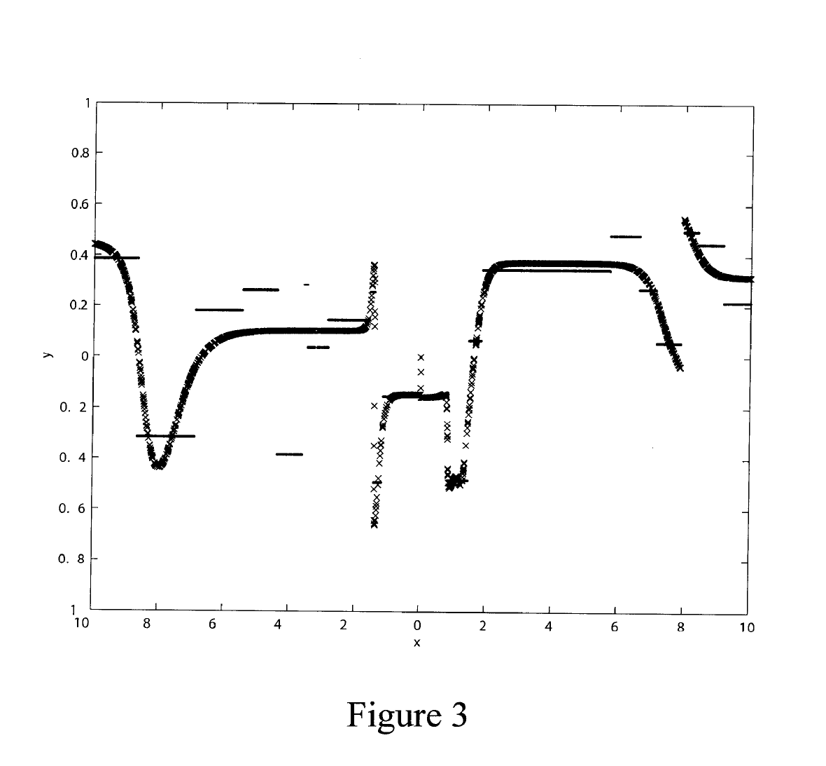

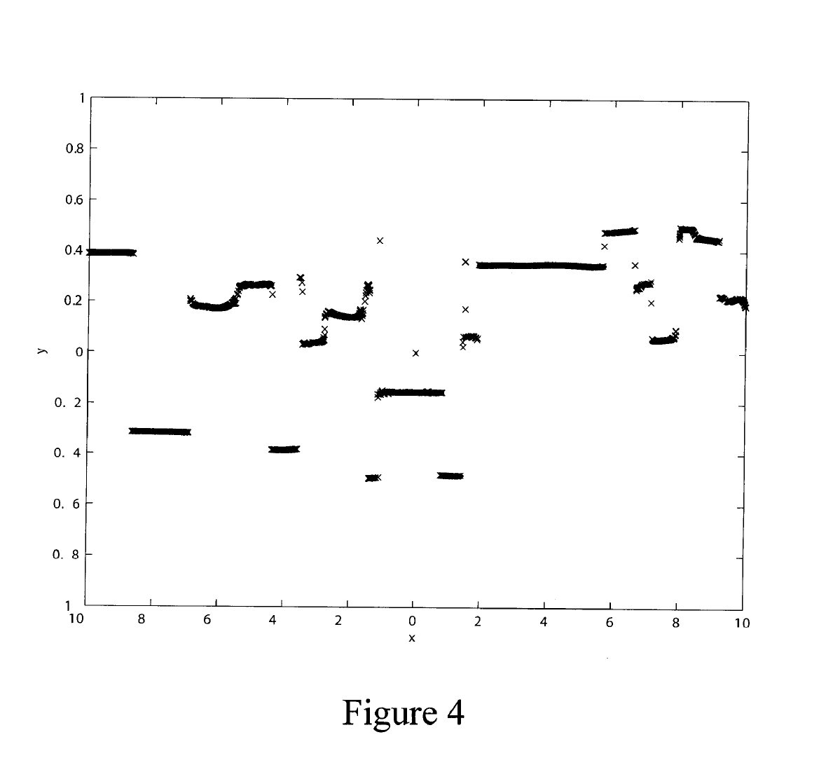

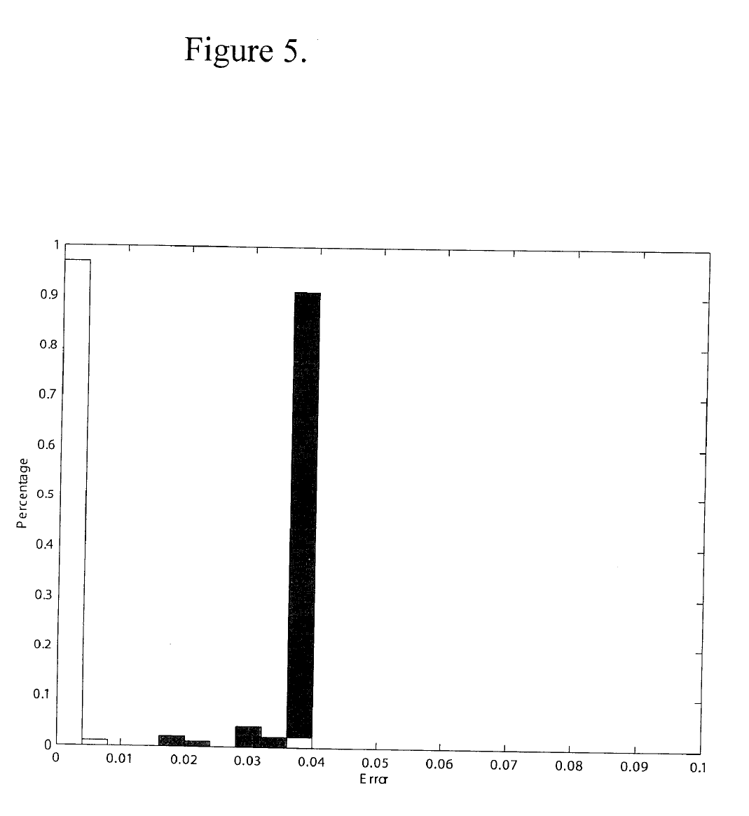

This example shows it is possible to learn a complex problem such as a steps function with a cascade of weak learners obtained with the procedure just mentioned. First, it was used a multilayer perceptron with 3 layers (20, 10, and 1 neurons respectively, all neurons bipolar save for the one in the output layer, which was linear). The multilayer perceptron was initialized with the Nguyen-Widrow rule [14], and trained with the iRPROP algorithm [15]. 1,000 samples were used to train 100 different instances of the multilayer perceptron (basically different weight initializations). The best performance of this weak learner is shown in FIG. 3. The same multilayer perceptron was used to implement a base block and a cascade of identity blocks in order to build the cascade of weak learners described before. As before, 100 different cascades were trained and the output of the one that showed best performance is in FIG. 4. A better way of seen how the procedure employed to build the cascade effectively improves the probability of obtaining systems that can solve the learning problem is seen in FIG. 5, where the performances of the cascade are consistently lower than those of the weak learner.

### APPLICATION EXAMPLES

Important applications of implementations of the resulting cascade of weak learners include the following:

### Application Example 1

The solution of difficult learning problems in classification and function approximation. Difficult learning problems are characterized for being associated to complex functions or to very high dimensionality problems.

### Application Example 2

A learning machine designed to learn the trajectories of the joints of a person, captures by a motion capture system, as this person performs a series of tasks. The resulting learning machine is able to simulate the movement of the person sequence in a broad variety of contexts. In other words, the system would be useful to generate synthetic representations of movements not done by the person but perfectly consistent with the way that person moves. Such a system could be used to produce synthetic actors or in computer games to produce realistic interactions between artificial characters.

### Application Example 3

A system similar to the one presented in the previous application could be used to produce reference trajectories for an anthropomorphic robot. As an example, the learning machine of the previous application would know where all the joints have to be and how the limbs have to move in order to execute a certain task. This reference trajectory can be used to control the robot and make it perform any physical task a human being can do.

The previous three examples of applications are not exhaustive, and there many other possible uses of the techniques previously explained.

The learning system offers a simple and practical solution for complex learning problems. It is an easy to implement ensemble of learning blocks that provides an excellent performance when it is compared to the prior art. Furthermore, implementation of the DSA has the additional advantages in that the possibility of using learning blocks that behave as identity systems simplifies training. Also, incremental learning keeps training simple, thanks to the fact that training is always constrained to the most recently added system. Therefore training remains a lower dimensionality problem, and there is no need of training the system as a whole. And, there are several alternatives for implementing the base and identity blocks: any learning machine will work.

While there has been shown and described what is considered to be preferred embodiments of the learning system, it will be understood that various modifications and changes in form or detail could readily be made without departing from the spirit of the invention. It is therefore intended that the invention be not limited to the exact forms described and illustrated, but should be constructed to cover all modification that may fall within the scope of the appended claims. Accordingly, the scope of the invention should be determined not by the embodiments illustrated, but by the appended claims and their legal equivalents.

### REFERENCES

[1] V. Vapnik, The Nature of Statistical Learning Theory. Springer, 1995.
[2] ______, Statistical Learning Theory. John Wiley and Sons, 1998.
[3] ______, “An overview of statistical learning theory,” IEEE Transactions on Neural Networks, vol. 10, no. 5, pp. 988-999, September 1999.
[4] J. A. K. Suykens, T. Van Gestel, J. De Brabanter, B. De Moor, and J. Vandewalle, Least Squares Support Vector Machine. World Scientific, Singapore, 2002.
[5] M. Mezard and J. Nadal, “Learning in feedforward layered networks: the tiling algorithm,” Journal of Physics A, vol. 22, pp. 2191-2203, 1989.
[6] M. Franco, “The upstart algorithm: a method for constructing and training feed-forward neural networks,” Neural Computation, vol. 2, pp. 198-209, 1990.
[7] S. Gallant, “Perceptron-based learning algorithms,” IEEE Trans. On Neural Networks, vol. 1, no. 2, pp. 179-191, June 1990.
[8] S. Fahlman and C. Lebiere, “The cascade-correlation learning architecture,” Carnegie Mellon University, Tech. Rep. CMU-CS-90-100, 1991.
[9] L. Breiman, “Bagging predictors,” Machine Learning, vol. 26, pp. 123-140, 1996.
[10] R. Schapire, “The boosting approach to machine learning: An overview,” in MSRI Workshop on Nonlinear Estimation and Classification, Berkeley, USA, 2002.
[11] W. Fang and R. Lacher, “Network complexity and learning efficiency of constructive learning algorithms,” in Proceedings of IEEE World congress on Computational Intelligence, 1994, pp. 366-369.
[12] E. Littmann and H. Ritter, “Cascade network architectures,” in Proceedings of the International Joint Conference on Neural Networks, 1992.
[13] R. Parek, J. Yang, and V. Honavar, “Constructive neural-network learning algorithms for pattern classification,” IEEE Transactions on Neural Networks, vol. 11, no. 2, pp. 436-451, March 2000.
[14] D. Nguyen and B. Widrow, “Improving the learning speed of 2-layer neural networks by choosing initial values of the adaptive weights,” in Proceedings of the IJCNN, 1990.
[15] C. Igel and M. H\ddot{}usken, “Improving the rprop learning algorithm,” in Proceedings of the Second International Symposium on Neural Computation, 2000, pp. 115-121.

I claim:

1. A method to solve complex problems, including classification, function approximation, and dynamic problems, wherein a cascade of weak learners is used, which employs any learning machine that uses an identity block to compose the input by the external input and that of the base block during the training process.

2. The method to solve complex problems according to claim 1, wherein for a set of N i.i.d. samples S_{N}={(xᵢ, ŷᵢ)}ᵢ₌₁^{N}, with xᵢε [symbol] ^{r}, and ŷᵢε [symbol] ^{s}, obtained from a process f: [symbol] ^{r}× [symbol] ^{t}→ [symbol] ^{s}, a performance index defines the approximation to the classical implementation function \hat{f}: R^{r}×R^{t}→R^{s}, the output ŷεR^{s} of the learning machine is defined by ŷ=\hat{f}(x, θ_{g}), with xεR^{r} its input, and θ_{f}εR^{t} the parameters that define the learning system; wherein a basis block implements the function g: R^{r}×R^{u}→R^{s}, which can be expressed as g(x, θ_{g}), with xεR^{r}, and θ_{g}εR^{u}, where θ_{g} sets the parameters that define the base function; and wherein the identity block is defined by h: [symbol] ^{r}× [symbol] ^{s}× [symbol] ^{v}→ [symbol] ^{s}, which can be expressed as h(x, ŷ, θ), with xεR^{r} (10), ŷεR^{s} (50), and θεR^{v}, the notation hⱼ denotes an identity block evaluated with the parameter vector θⱼ; comprising the steps of:
(1) training the base block g to be as close to the observed data as possible according to the chosen performance index, where initially the learning machine is composed only by the base block \hat{f}=g; and wherein if the achieved performance is adequate, then go to step 4, or else set the identity block index j to 0 and proceed to the next step;
(2) incrementing the identity block index to j=j+1 and adding a new identity block to the system, whereby the learning machine is mathematically defined by the nested system of equations
\hat{f}(x, θ_{f})=ŷⱼ
ŷⱼ=hⱼ(x, ŷⱼ₋₁, θⱼ) . . .
ŷ₁=h₁(x, b, θ₁)
b=g(x, θ_{g})
wherein θ_{f}=θ_{g}×θ₁× . . . ×θⱼ;
(3) freezing the parameter vectors θ_{g} and θₖ, kε{1, . . . j−1}, and training the newly added identity block, whose vector of parameters θⱼ is the only one that can change in θ_{f}, until a set of parameters that achieves the best possible performance index is found; and wherein if the newly found performance index improves, then go to step 2 to continue adding identity blocks, or else remove the last identity block, the one that was trained last, and go to the next step; and
(4) stopping.

3. The method to solve complex problems according to claim 1, wherein one or more performance indexes can be used, including the Euclidean distance and entropy.
